(19) United States
(12) Patent Application Publication
(10) Pub. No.: US 2007/0132360 A1
(43) Pub. Date: Jun. 14, 2007

(54) Low-pressure vapor discharge lamp with a mercury-free gas filling

(75) Inventors: Volker Dirk Hildenbrand, Eindhoven (NL); Maurice Jacques Sofie Elisabeth Sensen, Eindhoven (NL); Thomas Juestel, Witten (DE); Peter J. Schmidt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/578,457

(22) PCT Filed: Nov. 2, 2004
(86) PCT No.: PCT/IB04/52256

§ 371 Date: May 8, 2006

(30) Foreign Application Priority Data
Nov. 11, 2003 (EP) 03104155.1

(51) Int. Cl. H01J 1/62

(52) U.S. Cl. 313/486

(57) ABSTRACT

A low-pressure vapor discharge lamp has a radiation-transmitting discharge vessel (1) enclosing, in a gastight manner, a discharge space (3) provided with a gas filling. The gas filling is substantially free of mercury and comprises an indium compound and a buffer gas. The discharge vessel (1) comprises discharge means (2) for maintaining a gas discharge in the discharge space (3). The discharge vessel (1) is provided with a luminescent layer (4). The luminescent layer (4) comprises a luminescent material based on a nitridosilicate or on an oxonitridosilicate. Preferably, the luminescent material comprises rare-earth emitters. Preferably, the luminescent material comprises europium, cerium, or ytterbium emitters.

The invention relates to a low-pressure vapor discharge lamp comprising a radiation-transmitting discharge vessel with a mercury-free gas filling, means for maintaining a gas discharge, the discharge vessel being provided with a luminescent layer.

Light generation in low-pressure vapor discharge lamps is based on the principle that charge carriers, particularly electrons but also ions, are accelerated so strongly by an electric field between the electrodes of the lamp that collisions with the gas atoms or molecules in the gas filling of the lamp cause these gas atoms or molecules to be excited or ionized. When the atoms or molecules of the gas filling return to the ground state, a more or less substantial part of the excitation energy is converted into radiation.

Conventional low-pressure vapor discharge lamps comprise mercury in the gas filling. The mercury in the gas filling is being regarded more and more as an environmentally harmful and toxic substance that should be avoided as much as possible in present-day mass products as its use, production, and disposal pose a threat to the environment.

A further drawback of mercury low-pressure vapor discharge lamps is that mercury vapor primarily emits radiation in the short-wave, high-energy, but invisible UV-C range of the electromagnetic spectrum, which radiation must first be converted by the luminescent materials into visible radiation with a much lower energy level. In this process, the energy difference is converted into undesirable thermal radiation.

It is known that the spectrum of low-pressure vapor discharge lamps can be influenced by substituting the mercury in the gas filling with other substances.

International application WO-A 02/103 748 (=PH-DE 01 0180) discloses a low-pressure vapor discharge lamp comprising a gas discharge vessel with a gas filling containing an indium compound and a buffer gas, and comprising a luminescent layer containing at least one luminescent material emitting in the visible range of the spectrum. This patent application discloses a number of suitable luminescent materials.

A disadvantage of the known low-pressure vapor discharge lamp is that for the manufacture of highly efficient discharge lamps the radiation emitted by the discharge must be efficiently absorbed by the luminescent material and efficiently converted by the luminescent material into visible light of the desired wavelength.

The invention has for its object to eliminate the above disadvantage wholly or partly. According to the invention, a low-pressure vapor discharge lamp of the kind mentioned in the opening paragraph for this purpose comprises:
a radiation-transmitting discharge vessel enclosing, in a gastight manner, a discharge space provided with a gas filling,
the gas filling being substantially free of mercury and comprising an indium compound and a buffer gas,
the discharge vessel comprising discharge means for maintaining a gas discharge in the discharge space,
the discharge vessel being provided with a luminescent layer,
the luminescent layer comprising a luminescent material based on a nitridosilicate or an oxonitridosilicate.

In the lamp in accordance with the invention, a molecular gas discharge takes place at a low pressure, which gas discharge emits radiation in the visible and near UVA range of the electromagnetic spectrum. Apart from the characteristic lines of indium around 410 and 451 nm, said radiation also includes a wide continuous spectrum in the range from 320 to 450 nm. As this radiation originates from a molecular discharge, the type of indium compound, possible further additives as well as the internal lamp pressure, and the operating temperature enable the exact position of the continuous spectrum to be controlled.

The use of mercury is avoided in the low-pressure vapor discharge lamp according to the invention.

According to the invention, the luminescent layer comprises a luminescent material based on a nitridosilicate or on an oxonitridosilicate. Nitrides and oxide nitrides of the general type (M^{I},M^{II},M^{III})ₓSiₐO_{z}N_{b-z}(M^{I}═Mg, Ca, Sr, Ba, Zn; M^{II}═La, Gd, Y, Sc, Lu; M^{III}═B, Al, Ga, C, Ge) are mainly built up as a covalent anionic nitridosilicate network and are suitable host lattices for luminescent materials because of their relatively high thermal and chemical stability. In addition, luminescent materials based on a nitridosilicate or on an oxonitridosilicate rely on water as a solvent for the suspensions of the luminescent materials, which is an advantage for the relevant production processes from an environmental point of view.

In luminescenceconversion light-emitting diodes (LEDs), blue light emitted by the LED can be converted into light of longer wavelength by means of a luminescent material. Not wishing to be held by any particular theory, it is believed that in nitrides, because of the higher formal charge of N³⁻ compared with O²⁻ on the one hand and the nephelauxetic effect on the other hand, the ligand-field splitting of the 5d levels is larger and the centre of gravity of the 5d states occurs at lower energies than in an analogous oxygen environment. Luminescent nitride materials doped with suitable emitters can therefore be efficiently pumped with blue light.

The low-pressure vapor discharge lamp in combination with the luminescent layer according to the invention has a luminous efficacy that is substantially higher than that of conventional low-pressure vapor discharge lamps. The luminous efficacy, expressed in lumens/watt is the ratio between the brightness of the radiation in a specific visible wavelength range and the energy for generating the radiation. The high luminous efficacy of the lamp in accordance with the invention means that a specific quantity of light is obtained at a lower power consumption.

In addition, the losses caused by Stokes' displacement are relatively small for the luminescent material of the low-pressure vapor discharge lamp according to the invention. As a consequence, visible light with a relatively high luminous efficacy above 100 lumens/watt is obtained.

A preferred embodiment of the low-pressure vapor discharge lamp according to the invention is characterized in that the luminescent material comprises an oxonitridosilicate comprising aluminum. An aluminumcomprising oxonitridosilicate of the general type (M^{I},M^{II},M^{III})ₓS_{a-y}Al_{y}O_{z}N_{b-z}(M^{I}═Mg, Ca, Sr, Ba, Zn; M^{II}═La, Gd, Y, Sc, Lu; M^{III}═B, Ga, C, Ge) is also indicated as a so-called “sialon” or as SiAlON.

Suitable luminescent materials are luminescent materials based on host lattices such as nitrides, oxide nitrides, and SiAlONitrides. An advantage of these luminescent materials is that they are chemically stable and that their absorption in the UV and blue range of the spectrum is very strong. The latter is due to higher covalency of nitrides and oxide nitrides as compared with oxides. In addition, these luminescent materials have relatively high thermal quenching temperatures.

Luminescent nitride materials doped with rare-earth band emitters can be efficiently pumped with blue light. To this end a preferred embodiment of the low-pressure vapor discharge lamp is characterized in that the luminescent material comprises rare-earth emitters. Preferably, the luminescent material comprises europium, cerium, or ytterbium emitters. Such emitters, activated by ions Eu²⁺, Ce³⁺, or Yb²⁺, exhibit a relatively strong and broad absorption. In many of these host lattices, the absorption range extends from the blue to the UV-C, which makes these luminescent materials very useful for the conversion of the emission spectrum of the indium bromide (InBr) discharge and other molecular discharges.

Particularly suitable luminescent materials are luminescent material selected from the group formed by:
(Sr_{1-x-y-z}BaₓCa_{y})Si₂N₂O₂:Eu_{z}, where 0<x<0.2, 0<y<0.2 and 0<z<0.1;
Ca_{1-x-y}SrₓSi₂N₂O₂:Eu_{y}, where 0<x<0.5 and 0<y<0. 1;
(Sr_{1-x-y-z}CaₓBa_{y})₂Si₅N₈:Eu_{z}, where 0<x<1, 0<y<1 and 0<z<0.1;
(Sr_{1-x-y-z}BaₓCa_{y})₂Si₅₋ₐAlₐN₈₋ₐOₐ:Eu_{z}, where 0<x<1, 0<y<1, 0<z<0.1 and 0<a<4,
and
(Sr_{1-x-y-z}BaₓCa_{y})Si₂N₂O₂:Yb_{z} where 0<x<0.2, 0<y<0.2 and 0<z<0.1.

For these luminescent materials, the energy conversion ratio P_{visible}/P_{discharge} is of the order of 0.4 or higher, whereas the conversion ratio of the majority of known luminescent materials is well below 0.40.

Particularly advantageous effects as against the state of the art are provided by the invention if the emission from the luminescent materials in the luminescent layer together with the emission from the gas discharge forms white light.

The luminescent materials based on nitrides, oxide nitrides, and SiAlONes may be combined with luminescent materials selected from the group formed by:
Y₃Al₅O₁₂:Ce;
Lu₃Al₅O₁₂:Ce
(Y₁₋ₓGdₓ)₃(Al_{1-y}Ga_{y})₅O₁₂:Ce, where 0<x<1 and 0<y<1;
Sr₂CeO₄:Eu, Y₂O_{3:}Eu,Bi;
(Y,Gd)₂O₃:Eu,Bi;
Y(V,P)O₄:Eu;
Y(V,P)O₄:Eu,Bi;
(Sr,Mg,Ca)S:Eu;
Y₂O₂S:Eu;
(Ba,Sr)MgAl₁₀O₁₇:Eu,Mn;
ZnS:Cu,Al,Au; SrGa₂S₄Eu;
(Sr,Ba,Ca)(Ga,Al)₂S₄:Eu;
(Y,Gd)BO₃:Ce,Tb;
(Y,Gd)₂O₂S:Tb;
LaOBr:Ce,Tb;
(Ba,Sr)MgAl₁₀O₁₇:Eu;
(Ba,Sr)₅(PO₄)₃(F,Cl):Eu;
Y₂SiO₅:Ce;
ZnS:Ag,
and
La_{0.7}Gd_{0.3}OBr:Ce.

The group formed by Y₃Al₅O₁₂:Ce and (Y₁₋ₓGdₓ)₃(Al_{1-y}Ga_{y})₅O₁₂:Ce,

where 0<x<1 and 0<y<1, are orange-yellow luminescent materials emitting in the range from 520 to 590 nm.

The group formed by Sr₂CeO₄:Eu, Y₂O₃:Eu,Bi, (Y,Gd)₂O₃:Eu,Bi, Y(V,P)O₄:Eu, Y(V,P)O₄:Eu,Bi, (Sr,Mg,Ca)S:Eu, and Y₂O₂S:Eu are red luminescent materials emitting in the range from 580 to 650 nm.

The group formed by Lu₃Al₅O₁₂:Ce, (Ba,Sr)MgAl₁₀O₁₇:Eu,Mn, ZnS:Cu,Al,Au, SrGa₂S₄Eu, (Sr,Ba,Ca)(Ga,Al)₂S₄:Eu, (Y,Gd)BO3:Ce,Tb, (Y,Gd)₂O₂S:Tb, and LaOBr:Ce,Tb are green luminescent materials emitting in the range from 510 to 630 nm.

The group formed by (Ba,Sr)MgAl₁₀O₁₇:Eu, (Ba,Sr)₅(PO₄)₃(F,Cl):Eu, Y₂SiO₅:Ce, ZnS:Ag, and La_{0.7}Gd_{0.3}OBr:Ce are blue luminescent materials emitting in the range from 420 to 460 nm.

A further improved luminous efficacy is achieved if the discharge vessel is surrounded by an outer bulb, the outer surface of the discharge vessel being coated with the luminescent layer. In this case, the outer bulb also serves as a heat reflector.

These and other aspects of the invention are apparent from and will be elucidated with reference to the embodiments described hereinafter.

In the drawings:

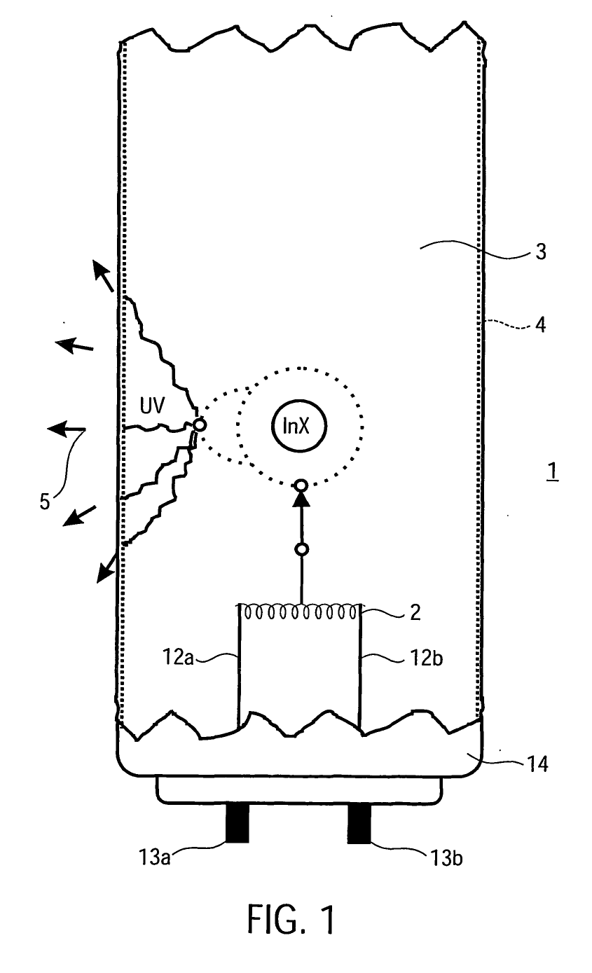

FIG. 1 shows the generation of light in a low-pressure vapor discharge lamp according to the invention comprising a gas filling containing an indium compound and a luminescent layer, and

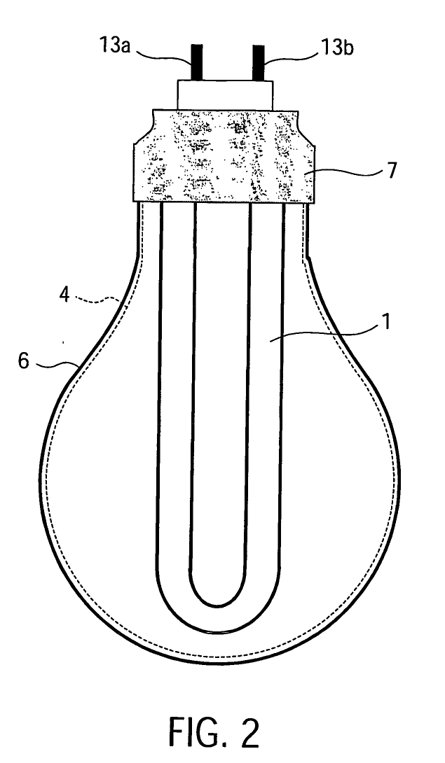

FIG. 2 is a cross-sectional view of an alternative embodiment of a low-pressure vapor discharge lamp in accordance with the invention.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1 schematically shows a low-pressure vapor discharge lamp in accordance with the invention. The low-pressure vapor discharge lamp is composed of a tubular radiation-transmitting discharge vessel 1. The wall of the discharge vessel 1 is preferably made of a glass type that is transparent to UV radiation having a wavelength between 300 and 450 mm. The discharge vessel 1 encloses, in a gastight manner, a discharge space 3 provided with a gas filling. The gas filling is substantially free of mercury and comprises an indium compound and a buffer gas. The discharge vessel 1 comprises discharge means 2 for maintaining a gas discharge in the discharge space 3. In the example of FIG. 1, the discharge means 2 are electrodes arranged in the discharge space 3. A suitable material for the electrodes comprises, for example, nickel, a nickel alloy, or a metal having a relatively high melting point, in particular tungsten and tungsten alloys. Composite materials of tungsten with thorium oxide or indium oxide are also suitable for use in the manufacture of the electrodes. Current-supply conductors 12a, 12b support the electrodes 20a; 20b, respectively, and issue from the discharge vessel 10 to the exterior. The current-supply conductors 12a, 12b are connected to contact pins 13a, 13b which are secured to a lamp cap 14.

An inert gas and an indium halide in a quantity of 1 to 10 μg/cm³ are used for the gas filling in the discharge space 3 in the simplest case.

The inert gas serves as a buffer gas, enabling the gas discharge to be more readily ignited. The buffer gas is preferably argon. Argon may be replaced, either completely or partly, with another inert gas, such as helium, neon, krypton, or xenon.

The luminous efficacy of the low-pressure vapor discharge lamp according to the invention can be dramatically improved by means of an additive selected among the group consisting of the halides of thallium, copper, and alkaline metals that is added to the gas filling. The luminous efficacy may also be improved by combining two or more indium halides in the gas atmosphere. The luminous efficacy may be further improved by optimizing the internal pressure of the lamp during operation. The cold filling pressure of the buffer gas is at most 500 mbar. Preferably, said pressure lies in a the range between 1 and 10 mbar.

It has been found that an increase in the luminous efficacy of the low-pressure vapor discharge lamp can be achieved by controlling the operating temperature of the lamp by means of suitable constructional measures. The diameter and the length of the lamp are chosen to be such that, during operation at an outside temperature of 25° C., an inside temperature in a range from 170 to 285° C. is attained. This inside temperature relates to the so-called “cold spot” of the gas discharge vessel as the discharge brings about a temperature gradient in the vessel.

To increase the temperature of the discharge space, the gas discharge vessel may also be coated with an infrared radiation reflecting layer. Preferably, use is made of an infrared radiation reflecting coating comprising indium-doped tin oxide. In this case it was found that, in a low-pressure vapor discharge lamp with a gas filling containing indium chloride, the temperature of the coldest spot during operation should lie in a range from 170 to 21° C., with a temperature of 200° C. being preferred. Similarly, in the case of a gas filling containing indium bromide, the temperature of the coldest spot should lie in a range from approximately 210 to 250° C., with a temperature of approximately 225° C. being preferred. In the case of a gas filling containing indium iodide, the temperature of the coldest spot should lie in a range from approximately 220 to 285° C., with a temperature of approximately 255° C. being preferred.

A combination of the three measures mentioned above also proved to be advantageous.

In the embodiment in accordance with FIG. 1, the inside surface of the gas discharge vessel of the lamp is coated with a luminescent layer 4. The luminescent layer 4 comprises a luminescent material based on a nitridosilicate or on an oxonitridosilicate. The radiation emitted by the low-pressure vapor discharge lamp has emission bands around 304, 325, 410, and 451 nm, as well as a continuous molecular spectrum in the visible blue range. This radiation excites the luminescent materials in the luminescent layer so as to emit light in the visible range 5.

Rare-earth emitters are very suitable as luminescent materials. In particular, the luminescent material comprises europium, cerium, or ytterbium emitters. Such emitters, activated by ions Eu²⁺, Ce²⁻, or Yb²⁺, exhibit a relatively strong and broad absorption. In many of these host lattices, the absorption range extends from the blue to the UV-C, which makes these luminescent materials very useful for the conversion of the emission spectrum of the indium bromide (InBr) discharge and other molecular discharges.

Particularly suitable luminescent materials are luminescent materials selected from the group formed by:
(Sr_{1-x-y-z}BaₓCa_{y})Si₂N₂O₂:Eu_{z}, where 0<x<0.2, 0<y<0.2 and 0<z<0.1;
Ca_{1-x-y}SrₓSi₂N₂O₂:Eu_{y}, where 0<x<0.5 and 0<y<0.1;
(Sr_{1-x-y-z}CaₓBa_{y})₂Si₅N₈:Eu_{z}, where 0<x<1, 0<y<1 and 0<z<0.1;
(Sr_{1-x-y-z}BaₓCa_{y})₂Si₅₋ₐAlₐN₈₋ₐOₐ:Eu_{z}, where 0<x<1, 0<y<1, 0<z<0.1 and 0<a<4,
and
(Sr_{1-x-y-z}BaₓCa_{y})Si₂N₂O₂:Yb_{z} where 0<x<0.2, 0<y<0.2 and 0<z<0.1.

The chemical composition of the luminescent materials in the luminescent layer and the chemical composition of the gas filling jointly determine the spectrum of the light emitted or its tone. The materials that can be suitably used as luminescent materials absorb the radiation generated and emit radiation in a suitable wavelength range, for example for the three primary colors red, blue, and green, and achieve a high fluorescent quantum yield. The emission of the low-pressure vapor discharge lamp in the UV and blue regions of the spectrum is supplemented so as to obtain white light in that three concepts in accordance with the invention are used for the luminescent materials in the luminescent layer:

In accordance with an embodiment of the invention, the luminescent materials or combinations of luminescent materials are, preferably, not provided on the inside of the discharge vessel 1 but on an outer surface thereof, as the radiation in the UV range from 300 nm to 450 nm generated by the indium-containing gas filling is not absorbed by the customary glass types.

FIG. 2 schematically shows a cross-sectional view of an alternative embodiment of a low-pressure vapor discharge lamp in accordance with the invention. The low-pressure vapor discharge lamp comprises a discharge vessel 1. Said discharge vessel 1 is tubular and folded, coiled, and/or multiply-bent so as to be U-shaped or having any other suitable shape. In addition, the discharge vessel 1 is enveloped by a pear-shaped outer bulb 6. The discharge vessel and the outer bulb 6 are mounted on a common base 7. The low-pressure vapor discharge lamp in FIG. 2 is provided with contact pins 13a, 13b. In an alternative embodiment, the low-pressure vapor discharge lamp is provided with a so-called Edison base for providing well-known mechanical and electrical connections. Any shape known from incandescent lamps may be selected for the outer bulb, for example a spherical shape, a candle shape, or a globule shape.

The discharge vessel 1 is preferably made of a glass type that is customarily used for the manufacture of incandescent lamps and luminescent tubes, for example a sodium lime silicate glass containing
69-73% SiO₂,
1-2% Al₂O₃,
3-4% MgO,
15-17% Na₂O,
4.2-4.6% CaO,
0.1-2% BaO, and
0.4-1.6% K₂O.
   These glass types are transparent to the radiation in the UV range from 300 nm to 450 nm generated by the indium-containing gas filling. The outer bulb may also be made from a customary lamp glass type. In addition, the wall of the outer bulb may be made of a material comprising a polymeric synthetic resin and one or more luminescent materials. Particularly suitable polymeric synthetic resins are polymethylmetacrylate (PMMA), polyethyleneterephtalate (THV), fluoroethylenepropylene (FEP), and polyvinyldifluoride (PVDF).

To provide the luminescent coating on the gas discharge vessel or the outer bulb, use may be made of dry coating methods such as electrostatic deposition or electrostatically supported sputtering, as well as a wet-coating method such as dip coating or spraying.

For wet-coating methods, the luminescent materials are dispersed in water, if necessary, in combination with a dispersing agent, a surfactant and an anti-foaming agent, or a binder preparation. Suitable binder preparations for a luminescent material in accordance with the invention comprise organic or inorganic binders that are capable of withstanding an operating temperature of 250° C. without decomposition, embrittlement, or discoloration. In an alternative embodiment, binders are used which can easily be burnt out at elevated temperatures, e.g. 250-500° C.

The solvent used for the luminescent preparation is preferably water to which a thickening agent such as polymethacrylic acid or polypropylene oxide is added. Customarily, further additives such as dispersing agents, defoaming agents and powder conditioners such as aluminum oxide, aluminum oxynitride, or boric acid are used. The luminescent preparation is provided on the inside of the outer bulb by pouring, flushing, or spraying. The coating is subsequently dried by means of hot air. The layers generally have a layer thickness in a range from 1 to 50 μm.

When the low-pressure vapor discharge lamp is ignited, the electrons emitted by the electrodes excite the atoms and molecules in the gas filling so as to emit UV radiation in a continuous spectrum in a range between 320 and 450 nm. The discharge heats up the gas filling such that the desired vapor pressure and the desired operating temperature ranging from 170 to 285° C., at which the light output is optimal, is achieved. The radiation in the UV ranges from 300 to 450 nm generated by the indium-containing gas filling is incident on the luminescent layer, causing said layer to emit visible radiation.

A number of experiments have been performed to test the performance of the luminescent materials as presented above. Since the layer thicknesses of the luminescent layers and the emission spectra of the various luminescent materials are different, the best manner to compare the performances of the various luminescent materials is to compare the conversion of the power of the discharge in the discharge space 3 with the “visible power” emitted by the low-pressure vapor discharge lamp. Conversion efficiency was compared for various luminescent layers of luminescent material, the thickness of the luminescent layers being chosen such that the layers are substantially free of the so-called line-of-sight transmission of the radiation of the discharge. The preparation of thicker layers is hampered by the limitations imposed by the viscosity of the suspensions. For this reason, the conversion efficiency was compared for layers with on average 8 particles above each other. The luminescent layers comprising the luminescent material were coated onto a glass tube, in the center of which a suitable burner with a suitable discharge radiation was placed. The discharge radiation emitted by this burner was allowed to excite the luminescent materials, and the emission of the glass tube provided with the luminescent layer and any residual emission of the discharge were measured in an integrating sphere. The discharge power was integrated from 310 to 360 mn, the visible power from 380 to 782 nm. The results are summarized in Table 1.

TABLE 1
Comparison of the performances of different luminescent powders, where
n is the average number of luminescent particles above each other,
P_{discharge} is the discharge power between 310 and 460 nm,
P_{VIS} is the visible radiation emission from excited luminescent material
between 380 and 782 nm, and
P_{VIS}/P_{discharge} is the energy conversion efficiency

| | | P_{discharge} | P_{VIS} | |
|---|---|---|---|---|
| | N | [W] | [W] | P_{VIS}/P_{discharge} |
| (Ba, Sr)₂SiO₄:Eu | 6.6 | 1.16 | 0.20 | 0.18 |
| Lu₃Al₅O₁₂:Ce | 8.3 | 1.28 | 0.34 | 0.26 |
| Y₃Al₅O₁₂:Ce | 7.3 | 1.22 | 0.27 | 0.22 |
| (Sr, Ca)₂SiO₄:Eu | 5.5 | 1.28 | 0.29 | 0.22 |
| SrS:Eu | 7.7 | 1.16 | 0.24 | 0.20 |
| YVO₄:Eu | 7.9 | 1.06 | 0.19 | 0.18 |
| SrSi₂N₂O₂:Eu | 8.0 | 1.23 | 0.67 | 0.54 |
| Sr₂Si₅N₈:Eu | 7.5 | 1.23 | 0.72 | 0.59 |

According to the results in Table I, the energy conversion ratios P_{VIS}/P_{discharge} of the luminescent materials used in the known low-pressure vapor discharge lamp are generally well below 0.40. The luminescent materials with a nitride or oxynitride lattice, i.e. SrSi₂N₂O₂:Eu and Sr₂Si₅N₈:Eu, achieve conversion ratios of the order of 0.40 or higher.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure vapor discharge lamp comprising a radiation-transmitting discharge vessel (1) enclosing, in a gastight manner, a discharge space (3) provided with a gas filling,
the gas filling being substantially free of mercury and comprising an indium compound and a buffer gas,
the discharge vessel (1) comprising discharge means (2) for maintaining a gas discharge in the discharge space (3),
the discharge vessel (1) being provided with a luminescent layer (4),
the luminescent layer (4) comprising a luminescent material based on a nitridosilicate or on an oxonitridosilicate.

2. A low-pressure vapor discharge lamp as claimed in claim 1, characterized in that the luminescent material comprises rare-earth emitters.

3. A low-pressure vapor discharge lamp as claimed in claim 2, characterized in that the luminescent material comprises europium, cerium, or ytterbium emitters.

4. A low-pressure vapor discharge lamp as claimed in claim 1, characterized in that the luminescent material comprises an oxonitridosilicate comprising aluminum.

5. A low-pressure vapor discharge lamp as claimed in claim 1, characterized in that the luminescent layer (4) comprises a luminescent material selected from the group formed by:
(Sr_{1-x-y-z}BaₓCa_{y})Si₂N₂O₂:Eu_{z}, where 0<x<0.2, 0<y<0.2 and 0<z<0.1;
Ca_{1-x-y}SrₓSi₂N₂O₂:Eu_{y}, where 0<x<0.5 and 0<y<0.1;
(Sr_{1-x-y-z}CaₓBa_{y})₂Si₅N₈:Eu_{z}, where 0<x<1, 0<y<1 and 0<z<0.1;
(Sr_{1-x-y-z}BaₓCa_{y})₂Si₅₋ₐAlₐN₈₋ₐOₐ:Eu_{z}, where 0<x<1, 0<y<1, 0<z<0.1 and 0<a<4,
and
(Sr_{1-x-y-z}BaₓCa_{y})Si₂N₂O₂:Yb_{z} where 0<x<0.2, 0<y<0.2 and 0<z<0.1.

6. A low-pressure vapor discharge lamp as claimed in claim 1, characterized in that the luminescent layer (4) further comprises a luminescent material selected from the group formed by:
Y₃Al₅O₁₂:Ce;
(Y₁₋ₓGdₓ)₃(Al_{1-y}Ga_{y})₅O₁₂:Ce, where 0<x<1 and 021 y<1;
Sr₂CeO₄:Eu, Y₂O₃:Eu,Bi;
(Y,Gd)₂O₃:Eu,Bi;
Y(V,P)O₄:Eu;
Y(V,P)O₄:Eu, Bi;
(Sr,Mg,Ca) S:Eu;
Y₂O₂S:Eu;
(Ba,Sr)MgAl₁₀O₁₇:Eu,Mn;
ZnS:Cu,Al,Au; SrGa₂S₄Eu;
(Sr,Ba,Ca)(Ga,Al)₂S₄:Eu;
(Y,Gd)BO₃:Ce,Tb;
(Y,Gd)_{2O}₂S:Tb;
LaOBr:Ce,Tb;
(Ba,Sr)MgAl₁₀O₁₇:Eu;
(Ba,Sr)₅(PO₄)₃(F,Cl):Eu;
Y₂SiO₅:Ce;
ZnS:Ag,
and
La_{0.7}Gd_{0.3}OBr:Ce.

7. A low-pressure vapor discharge lamp as claimed in claim 1, characterized in that the emission from the luminescent layer (4) and the emission from the gas discharge together form white light.

8. A low-pressure vapor discharge lamp as claimed in claim 1, characterized in that the discharge vessel is surrounded by an outer bulb, the outer surface of the discharge vessel being coated with the luminescent layer.

9. A low-pressure vapor discharge lamp as claimed in claim 1, characterized in that the discharge vessel (1) is surrounded by an outer bulb (6), the outer bulb (6) being coated with the luminescent layer (4).
